(19) United States
(12) Patent Application Publication
(10) Pub. No.: US 2003/0233470 A1
(43) Pub. Date: Dec. 18, 2003

(54) Network storage data redirection

(75) Inventors: Edward Glen Britton, Chapel Hill, NC (US); Wesley McMillan Devine, Apex, NC (US); Lap Thiet Huynh, Apex, NC (US); Bala Rajaraman, Raleigh, NC (US); Arthur James Stagg, Raleigh, NC (US)

Correspondence Address: Jerry W. Herndon, IBM Corporation T81/503, PO Box 12195, Research Triangle Park, NC, 27709, US

(73) Assignee: International Business Machines Corporation, Armonk, NY (US)

(21) Appl. No.: 10/171,504

(22) Filed: Jun. 12, 2002

(51) Int. Cl. G06F 15/173

(52) U.S. Cl. 709/238

(57) ABSTRACT

A data re-direction method can include receiving a data re-direction request from an application server; identifying from the data re-direction request at least one data re-direction primitive, the primitive including at least one data element selected from the group consisting of a client identity and a client type; retrieving personalized data according to subsequent client data requests associated with the at least one data re-direction primitive; and, forwarding the retrieved personalized data directly to a POC corresponding to the client data requests without first passing the retrieved personalized data through the application server.

### BACKGROUND OF THE INVENTION

1. Statement of the Technical Field

The present invention relates to the retrieval of data from network storage and more particularly to the redirection of retrieved data directly from network storage to requesting points of contact.

2. Description of the Related Art

The modern global network can be viewed as a complex interweaving of multiple network technologies, server platforms, client capabilities and application requirements. Within the modern global network, it has become important to provide differentiated Quality of Service (QoS) to different customers so that some customers receive a higher level of service than other customers on the network. Additionally, it has become important to personalize content provided to customers. Both QoS and personalization are critical components of e-commerce inasmuch as a customer always can be viewed as merely “one click away” from a competitor's network content where response times falter, content is not immediately meaningful, or if multiple steps are required to access content.

To overcome the inherent difficulties of conducting e-commerce across the global network and to provide the most efficient computing environment, a number of approaches have been pursued. First, static data and indeed, dynamic data, have been cached at the network edge to provide for quick response times. Second, content has become personalized according to the characteristics of the customer. Such personalized content can include, for instance, business volume, client identity, historical purchasing trends, and the like. In this way, meaningful content can be delivered to end-users with little transmission latency.

Ordinarily, it can be assumed that the combination of caching and personalization can suffice for producing a viable e-commerce environment. Yet, the emergence of new storage technologies have complicated matters. Specifically, the prototypical data driven e-commerce architecture presumes the close association of data store and application logic. Thus, any latencies experienced in the delivery of personalized content can be assumed to originate in one of the network or application server components. The addition of network storage, such as network attached storage (NAS) or a storage area network (SAN), however, has introduced the previously non-existent potential for additional network latencies.

FIG. 1 is a schematic illustration of an e-commerce system known in the prior art. As shown in FIG. 1, a client computing device 110 can forward a service request 160 to an application server 130 over the computer communications network 120. The application server 130 can determine from the service request 160 that particular personalized data stored in network storage 150 will be required. As will be recognized by one skilled in the art, network storage 150 can range from NAS to a SAN, and all intermediate latency prone network storage topologies.

In any case, the application server 130 can issue a data request 170 to the network storage 150 over a second computer communications network 140. Following some delay, the network storage 150 can respond to the data request 170 by serving data 180 to the application server 130. The application server 130, in turn, can use the data 180 to produce a result 190 to be provided to the client 110. Importantly, as will be apparent to the skilled artisan, though the latencies arising from the operation of the application server 130 can be minimized to some extent by the use of caching and edge server strategies, the additional latencies introduced by the network storage 150 cannot be so easily minimized. Thus, it would be advantageous to incorporate a process and system within the e-commerce system shown in FIG. 1 which can minimize the latencies introduced by the network storage 150.

### SUMMARY OF THE INVENTION

The present invention is a personalized data re-direction system and method. The system can include at least one data request agent (DRA) disposed in at least one corresponding client point of contact (POC). Each DRA can have a configuration for requesting data re-direction for personalized data associated with one of a particular client and a particular client type. A data request manager (DRM) can be disposed in an application server and can be configured both to process data re-direction requests received from a DRA and to request data re-direction for the personalized data associated with the particular client or the particular client type. The requested personalized data can include at least one set of personalized information selected from the group consisting of historical purchasing trend information, interest information, credit information, inventory information, pricing information, and discount information.

Finally, a data transmission manager (DTM) can be disposed in network storage and configured to respond to requests for personalized data received from a DRM. Specifically, the DTM can respond by directly forwarding the requested personalized data to a requesting client through one of the DRAs in a corresponding client POC. Notably, the network storage can include network attached storage (NAS) or a storage area network (SAN). Additionally, the POC can be an edge server. In that case, the edge server can include a consolidation component configured to consolidate personalized data associated with a single unit of work, Specifically, the personalized data can be retrieved directly from multiple individual DTMs, each individual DTM being disposed in different network storage.

A data re-direction method can include the steps of: receiving a data re-direction request from an application server; identifying from the data re-direction request at least one data re-direction primitive, the primitive including at least one data element selected from the group consisting of a client identity and a client type; retrieving personalized data according to subsequent client data requests associated with the at least one data re-direction primitive; and, forwarding the retrieved personalized data directly to a POC corresponding to the client data requests without first passing the retrieved personalized data through the application server. Notably, the identifying step can include identifying from the data re-direction request at least one data re-direction primitive, the primitive including at least one data element selected from the group consisting of a client identity and a QoS rating; and, further identifying a unit of work associated with the data re-direction request. Moreover, the identifying step further can include identifying at least one of POC network address information and a security association.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a schematic illustration of a conventional e-commerce architecture configured with network storage, known in the art;

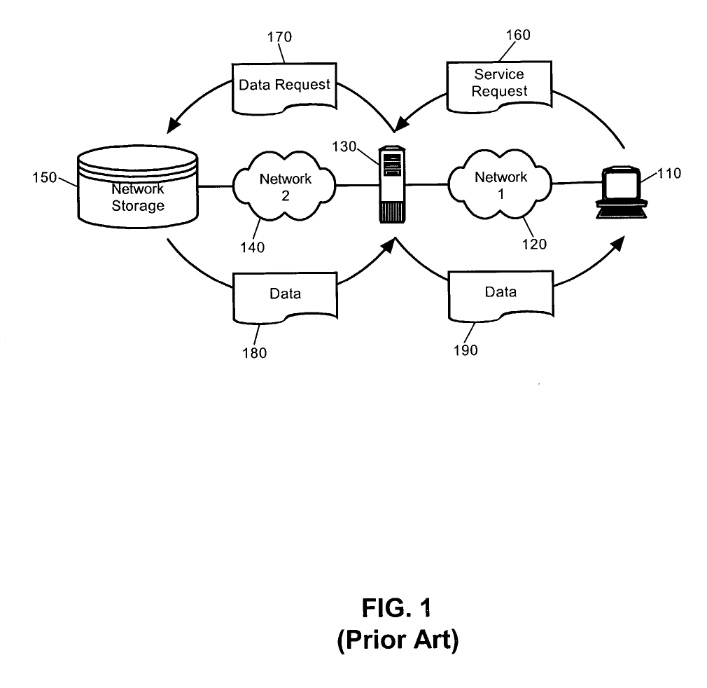

FIG. 2 is a schematic illustration of an e-commerce architecture configured to re-direct personalized content from network storage to a point of contact in accordance with the present invention;

FIG. 3 is a block diagram illustrating a re-direction architecture; and,

FIG. 4 is an event diagram depicting a process for re-directing personalized content in the re-direction architecture of FIG. 3.

### DETAILED DESCRIPTION OF THE PREFERRED EMBODIMENTS

The present invention is a network storage re-direction process and system. In accordance with the present invention, data requests originating in a client POC in an e-commerce system can be processed in an application server configured with communicatively linked network storage. The network storage can include latency prone network storage such as a NAS or a SAN. The application server can request personalized content from the network storage which, in response thereto, can forward the requested personalized content not to the application server, but directly to the POC. In this way, any latencies which may be introduced in the communication path between application server and network storage can be eliminated thereby minimizing the response time of the e-commerce system.

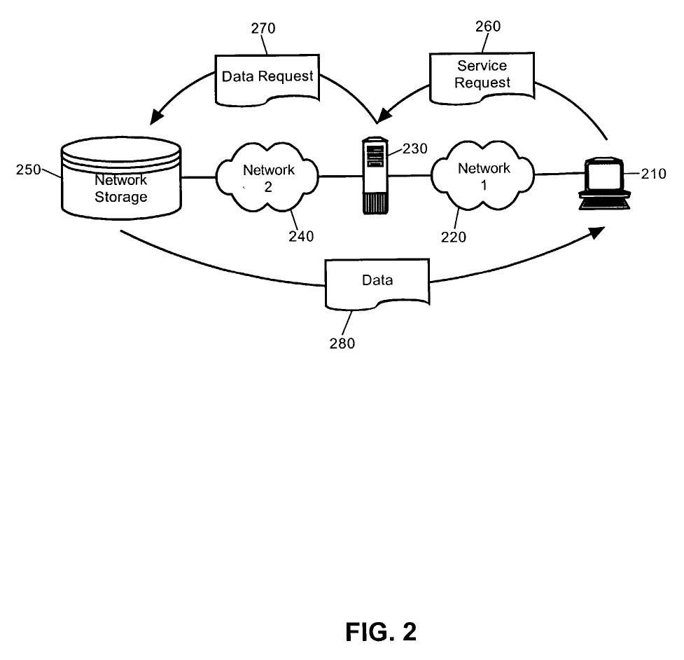

FIG. 2 is a schematic illustration of an e-commerce architecture configured to re-direct personalized content from network storage to a POC in accordance with the present invention. The e-commerce architecture shown in FIG. 2 can include a POC 210 configured to forward service requests 260 to one or more application servers 230 across a computer communications network 220. The POC 210 can represent the entry point in the e-commerce architecture for an end user. Thus, a POC can include, but will not be limited to, an edge server, gateway to a handheld device, a network proxy, etc. The end-user, of course, can include a person in a business-to-consumer environment, or a business entity in a business-to-business environment.

The application server 230 can include be configured to forward requests 270 for personalized content to network storage 250 which can be communicatively linked across a data storage network 240. The network storage 250 can include non-direct attached storage such as one or more instances of a NAS or SAN. On demand, the network storage 250 can retrieve personalized content such as that content associated with the identity of a requesting client, the business volume of a client, historical purchasing trends of the requesting client, etc. Once retrieved, the personalized content 280 can be forwarded directly to the requesting POC 210 without first passing through the application sever 230.

Importantly, though the architecture illustrated in FIG. 2 includes two independent computer communications networks 220, 240, the invention is not so limited. Rather, in other equally preferred embodiments, each of the POC 210, application server 230 and network storage 250 can be communicatively linked across a single computer communications network. Of course, where both networks 220, 240 are included as part of a global network of networks such as the Internet, data can travel freely between one or more networks. In any case, in accordance with the present invention, network latencies can be minimized by the network storage 250 providing requested personalized data directly to the POC 210.

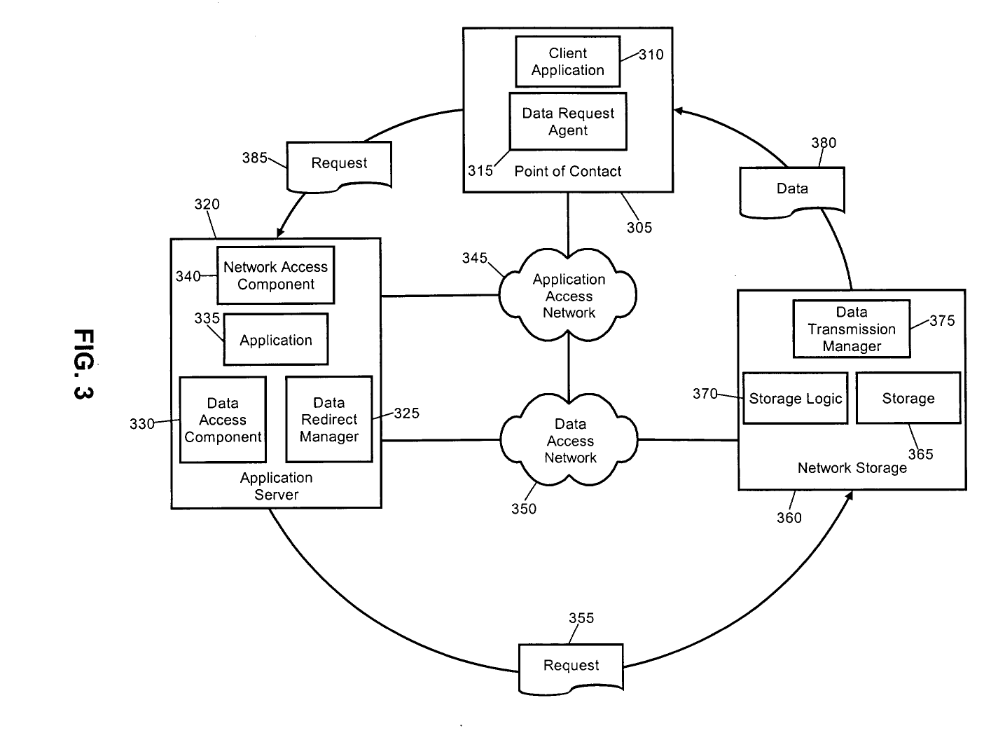

FIG. 3 is a block diagram illustrating a re-direction architecture similar to the architecture shown in FIG. 2. As shown in FIG. 3, a DRA 315 can be disposed within the POC 305. Similarly, a DRM 325 can be disposed within the application server 320, as a data transmission manager DRM 375 can be disposed in network storage 360. A client application 310 further can be included in the POC 305 to handle the primary data processing functionality of the POC 305, such as where the POC 305 is an edge server, or a proxy server.

The application server 320, in addition to hosting the DRM 325, can include a data access component 330 configured to retrieve required data from network storage 360 over the data access network 350. The application server 320 further can include a network access component 340 through which access to the application 335 by the POC 305 over the application access network 345 can be facilitated. Finally, the network storage 360 can include fixed storage 365 and base storage logic 370 with which data can be stored in and retrieved from the fixed storage 365.

In operation, the DRA 315 can initiate a request to re-direct data from network storage 360 to the client application 310. Also, the DRA 315 can associate re-directed data 380 to a particular application and a corresponding client. The DTM 375, by comparison, can process data re-direct requests 355 received from the DRM 325 in the application server 320. In consequence, the DTM 375 can respond to selected data requests 355 by re-directing requested data 380 directly the DRA 315 in the POC 305. Finally, the DRM 325 can initiate and forward data re-direct requests 355 to the DTM 375. Still, where requested data can be found in a caching portion of the application server 320, the DRM 325 can arrange a direct data transfer of the requested data from the application server 320 to the POC 305.

Notably, to facilitate data re-direction, a set of primitives can be defined for controlling data flow between the application server 320 and the network storage 360. In particular, the primitives can be used by the network storage to accurately identify the POC 305 and to forward requested data directly to the POC 305. The primitives can include, for instance, a work-unit identifier able to uniquely identify a unit of work across the application access network 345 and the data access network 350. In one aspect of the invention, the work-unit identifier can include a concatenation of network addresses, server names and application identifiers.

Aside from the work-unit identifier, the primitives also can include network addressability data. Specifically, sufficient network address information for the POC 305 can be provided such that the network storage 360 can determine whether a connection between network storage 360 and POC 305 already exists. Where no connection exists, the network storage 360 can use the network addressability data to establish a connection with the POC 305. Finally, a security association can be included among the primitives. The security association can enable the network storage 360 to conform to the security requirements which have been established by the initial client connection. For instance, the security association can include SSL connection identifiers, keys or certificates.

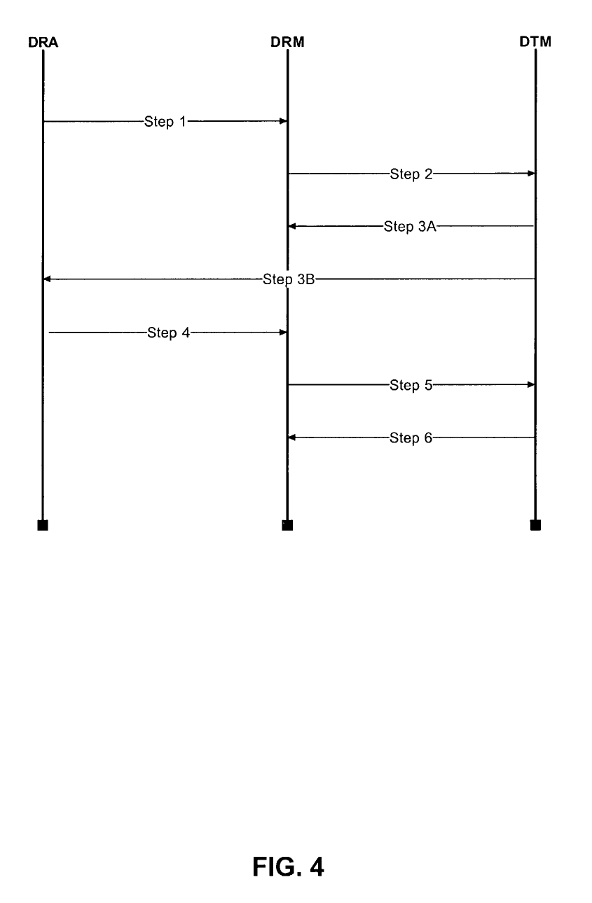

FIG. 4 is an event diagram depicting a process for re-directing personalized content in the re-direction architecture of FIG. 3. Initially in step 1, subsequent to a client having established a connection to the application network through a POC. Once the connection has been established, the identity of the client can be determined as can a QoS rating. Both the identity of the client and the QoS data can be determined through the use of one or more conventional methods, such as cookie inspection, cache lookup, use of a source IP address, client authentication, and the like. If neither the client identity nor the QoS rating can be determined, the connection can proceed conventionally, without data re-direction. Otherwise, the DRA can notify the DRM of the client request and can pass the requisite primitives to the DRM.

In step 2, upon receipt of the qualified request from which the client or QoS rating can be determined, the DRM can further determine whether personalized data pertinent to the unit work specified by the primitives ought to be re-directed to the DRA. This further determination can be achieved through application specific information available to the DRM, such as data defining end-user characteristics including the enduser's identity, or business characteristics including inventory, pricing, historical purchasing patterns, and the like. Once determining pertinent personalized data, the DRM can construct an appropriate data re-direction request for transmission to the DTM.

In step 3A, the DTM can acknowledge the receipt of the data re-direction request. In step 3B, the DTM further can retrieve the personalized data requested by the client and can forward the requested personalized data to the DRA. In this regard, where a connection already exists between the DTM and the DRA, the existing connection can be used to carry the requested personalized data between the DTM and the DRA. Otherwise, where a connection does not yet exist between the DTM and the DRA, a new connection can be established based upon the addressing data contained in the primitives forwarded to the DTM by the DRM. In both cases, however, the work unit identifier can be included when establishing the connection so that the POC can correctly route the personalized data to the client.

Once a connection has been established between the DTM and the DRA, the DRA will possess the required data to locally process the request of the client. The processing of the request, of course, can include many steps, not illustrated in FIG. 4. Specifically, the client transaction can flow to the DRM in which actual processing can occur as can database updating. In any case, in step 4, when client processing has completed, the DRA can notify the DRM. The notification can include, for example, required database updates which are yet to be processed in network storage. The DRM, in turn, can forward the required database updates to the DTM in step 5. As the DRM rather than the DRA instructs the DTM to update the database, database integrity and consistency can be maintained. Finally, in step 6 the DTM can respond to the DRM when all required database updates have been completed.

Importantly, the transaction flow illustrated in FIG. 4 can be extended to include complex transaction processing. Specifically, units of work which originate in a client, but are processed across multiple application servers can be processed using the data re-direction architecture of the present invention. In particular, as a work-unit identifier can be associated with each DTM-to-DRA connection, the DRA can associate incoming personalized data with a particular unit of work. As the personalized data is received in the DRA, the POC can consolidate the personalized data as if the personalized data had been forwarded by a single application server.

In consequence of the present invention, network traffic can be reduced by the elimination fo the need for all requested data to first flow to the application server prior to flowing to the POC. Additionally, network transmission errors which require retransmission can be reduced because of the decrease in the number of data transfers required. Also, recovery from data transmission failures can occur simply and more rapidly as recovery involves merely to network end-points rather than three. Finally, not only can the cost of managing the e-commerce architecture be reduced in accordance with the present invention, but also, the potential for client satisfaction can increase in consequence of faster personalized data delivery to the POC. Thus, the data re-direction architecture and process of the present invention can provide a simplified approach to minimizing network latencies experienced with remote network storage.

The present invention can be realized in software in a centralized fashion in one computer system, or in a distributed fashion where different elements are spread across several interconnected computer systems. Any kind of computer system, or other apparatus adapted for carrying out the methods described herein, is suited to perform the functions described herein. typical centralized implementation could include a general purpose computer system with a computer program that, when being loaded and executed, controls the computer system such that it carries out the methods described herein.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A personalized data re-direction system comprising:
at least one data request agent (DRA) disposed in at least one corresponding client point of contact (POC), each said DRA having a configuration for requesting data re-direction for personalized data associated with one of a particular client and a particular client type;
a data request manager (DRM) disposed in an application server and configured both to process data re-direction requests received from a DRA and to request data re-direction for said personalized data associated with said one of a particular client and particular client type; and,
a data transmission manager (DTM) disposed in network storage and configured to respond to requests for personalized data received from a DRM by directly forwarding said requested personalized data to a requesting client through one of said at least one DRAs in said at least one corresponding client POC.

2. The system of claim 1, wherein said network storage comprises network storage selected from the group consisting of network attached storage (NAS) and a storage area network (SAN).

3. The system of claim 1, wherein said POC comprises an edge server.

4. The system of claim 1, wherein said requested personalized data comprises at least one set of personalized information selected from the group consisting of historical purchasing trend information, interest information, credit information, inventory information, pricing information, and discount information.

5. The system of claim 3, wherein said edge server comprises a consolidation component configured to consolidate personalized data associated with a single unit of work, wherein said personalized data is retrieved directly from multiple individual DTMs, each said individual DTM being disposed in different network storage.

6. A data re-direction method, said method comprising the steps of:
receiving a data re-direction request from an application server;
identifying from said data re-direction request at least one data re-direction primitive, said primitive comprising at least one data element selected from the group consisting of a client identity and a client type;
retrieving personalized data according to subsequent client data requests associated with said at least one data re-direction primitive; and,
forwarding said retrieved personalized data directly to a point of contact (POC) corresponding to said client data requests without first passing said retrieved personalized data through said application server.

7. The method of claim 6, wherein said identifying step comprises the steps of:
identifying from said data re-direction request at least one data re-direction primitive, said primitive comprising at least one data element selected from the group consisting of a client identity and a Quality of Service (QoS) rating; and,
further identifying a unit of work associated with said data re-direction request.

8. The method of claim 7, wherein said identifying step further comprises the steps of yet further identifying at least one of POC network address information and a security association

9. A machine readable storage having stored thereon a computer program for re-directing personalized data, said computer program comprising a routine set of instructions for causing the machine to perform the steps of:
receiving a data re-direction request from an application server;
identifying from said data re-direction request at least one data re-direction primitive, said primitive comprising at least one data element selected from the group consisting of a client identity and a client type;
retrieving personalized data according to subsequent client data requests associated with said at least one data re-direction primitive; and,
forwarding said retrieved personalized data directly to a point of contact (POC) corresponding to said client data requests without first passing said retrieved personalized data through said application server.

10. The machine readable storage of claim 9, wherein said identifying step comprises the steps of:
identifying from said data re-direction request at least one data re-direction primitive, said primitive comprising at least one data element selected from the group consisting of a client identity and a Quality of Service (QoS) rating; and,
further identifying a unit of work associated with said data re-direction request.

11. The machine readable storage of claim 10, wherein said identifying step further comprises the steps of yet further identifying at least one of POC network address information and a security association.
